(19) United States
(12) Patent Application Publication
(10) Pub. No.: US 2003/0120896 A1
(43) Pub. Date: Jun. 26, 2003

(54) System on chip architecture

(76) Inventors: Jason Gosior, Edmonton (CA); Colin Broughton, Edmonton (CA); Phillip Jacobsen, Edmonton (CA); John Sobota, Edmonton (CA)

Correspondence Address: Rodman & Rodman, 7 South Broadway, White Plains, NY, 10601, US

(21) Appl. No.: 09/896,221

(22) Filed: Jun. 29, 2001

(51) Int. Cl. G06F 9/00

(52) U.S. Cl. 712/32; 712/228

(57) ABSTRACT

An embedded processor system having a single-chip embedded microprocessor, with analog and digital electrical interfaces to external systems, that is suitable for implementation in various integrated circuit technology formats. A processor core uses pipelined execution of multiple independent or dependent concurrent threads, together with supervisory control for monitoring and controlling the processor thread state and access to other components. The pipeline enables simultaneous execution of multiple threads by selectively avoiding memory or peripheral access conflicts through the types of pipeline stages chosen and the use of dual and tri-port memory techniques. The single processor core executes one or multiple instruction streams on multiple data streams in various combinations under the control of single or multiple threads. The invention can also support a programmable clock mechanism, thread-level monitoring capability, and power management capability.

### BACKGROUND OF THE INVENTION

The invention relates to the field of single-chip embedded microprocessors having analog and digital electrical interfaces to external systems. More particularly, the invention relates to an embedded processor useful with logic based and memory based integrated circuit technologies.

Technology optimization strategies for digital logic versus high density digital memory have developed in different directions. Large memories such as dynamic random access memory (“DRAM”) emphasize cost and related power optimization. DRAM costs are reduced by increasing circuit density, wafer productivity, manufacturing efficiency and by creating high volume standardized processes. The circuit density of DRAM lowers the power consumption per unit area when compared with digital logic for an equivalent number of gates. Logic technology is driven by gate-switching-time performance with cost as a secondary consideration. Differences between logic and memory integrated circuit technologies and the challenges of embedding DRAM in conventional processors was discussed in IEEE Spectrum, April 1999, “Embedded DRAM Technology: Opportunities and Challenges”.

Digital logic designers such as processor designers are extremely concerned with circuit timing and signal skew. As the number of logic gates in multiple, parallel-dependent logic paths grows, the timing of signals propagating through these chains of gates is critical. If signal timing is not managed carefully the logical results output from gates can be in error because intermediate digital signals will not trigger gates during a proper timing interval in performing a logic operation. As designs become more complex and faster, the logic gate switching and propagation times are necessarily reduced.

Memory and processor/peripheral logic is commonly integrated on a single integrated circuit in popular microprocessors such as the Pentium and PowerPC chips. In conventional situations this memory is used for registers and on-chip caches. Traditionally memory cells integrated into the processor chip are physically larger than in stand-alone commodity memory cells and typically comprise static random access memory (“RAM”) type which do not require periodic power refreshes like the cheaper and denser dynamic RAM found in separate chips. On-processor-chip memory is fabricated with a similar or hybrid integrated circuit process technology and usually exhibits high performance like the processor itself.

Integrated circuits combining both memory and processor/peripheral logic on memory-type integrated circuit process technology are also known. Such circuits emphasize memory access efficiency enhancements or address specialized, highly parallel, computational architectures not readily programmable using conventional tools. Such circuits are suitable as coprocessors but have limited use in other applications.

In certain conventional systems, logic is embedded in memory circuits in “intelligent memory” devices that function as conventional memories and have special extended memory functions. U.S. Pat. No. 4,037,205 to Edelberg et al. (1977) described a digital memory with data manipulation capabilities including the capability of performing an ascending or descending sort, associative searches, updating data records and dynamic reconfiguration of the memory structure. U.S. Pat. No. 5,677,864 to Chung (1997) described a multi-port memory device that performed a variety of memory data manipulations of varying complexity including summing, gating, searching and shifting on behalf of a host. U.S. Pat. No. 6,097,403 to McMinn (2000) described a main memory comprising one or more memory devices that included logic for performing a predetermined graphics operation upon graphics primitives stored within the memory devices.

Examples of more general processors embedded in memory also exist but function as co-processors to external central processors. U.S. Pat. No. 5,751,987 to Mahant-Shetti et al. (1998) described memory chips with data memory, embedded logic and broadcast memory capable of localized computation and processing of the data in memory. U.S. Pat. Nos. 5,475,631 and 5,555,429 to Parkinson et al. (1995 and 1996 respectively) described integrated circuits including a random access memory array, serial access memory, an arithmetic logic unit, a bi-directional shift register, and masking circuitry. Such circuits enabled arithmetic operations such as multiplication and addition of up to 2048 bit wide data records. U.S. Pat. No. 6,226,738 to Dowling (2001) described a split processing architecture including a first central processing unit (“CPU”) core portion coupled to a second embedded dynamic random access memory (DRAM) portion. Embedded logic on DRAM chips implemented the memory intensive processing tasks and reduced the amount of traffic bussed back and forth between the CPU core and the embedded DRAM chips. U.S. Pat. No. 5,678,021 to Pawate et al. (1997) described a smart memory that included data storage and a processing core for memory intensive functions directed by a central processing unit separate from the processing core. U.S. Pat. No. 5,396,641 to Iobst et al. (1995) described a chip containing multiple single-bit computational processors driven in parallel to perform massively parallel processing operations.

Various strategies for watchdog processes have been developed to enhance and monitor the robustness of developmental and mission critical systems. Conventional processors use count down clocks that trigger a system reset if the processor does not service the count down clock on regular intervals. This prevents a processor from locking up in system critical applications. U.S. Pat. No. 6,161,196 to Tsai (2000) described a software-based system where multiple copies of the same application were run in multiple remote controllers and the correctness of the results were compared and checked by a central instrumentation tool. If a fault was detected on a given controller a recovery action was implemented. U.S. Pat. No. 6,138,251 to Murphy et al. (2000) described a system consisting of a central server node using a node failure protocol in order to accurately track the foreign reference counts of remote nodes in view of node failures. U.S. Pat. No. 5,684,807 to Bianchini et al. (1997) described an adaptive distributed diagnostic system where multiple nodes communicate with each other by a network to test the state of the other. U.S. Pat. No. 5,692,193 to Jagannathan et al.(1997) described a software architecture for control of highly parallel computer systems in which virtual process policy managers decide where to move the virtual processes of a fault tolerant virtual machine when a physical processor fails.

Examples of clock compensation methods for variable crystal inputs exist in the prior art. U.S. Pat. No. 4,903,251 to Chapman (1990) described a system that corrected a time-of-day clock having a time base derived from an inexpensive crystal with variable oscillating frequency characteristics. This system did not create a reliable system reference frequency signal but instead created a time-of-day clock value. U.S. Pat. No. 4,448,543 to Vail (1984) described a time-of-day clock with temperature compensation and update capability correlating to a highly accurate frequency reference. U.S. Pat. No. 5,644,271 to Mollov et al. (1997) described a system that used a temperature error table to compensate for crystal frequency variations due to temperature change. U.S. Pat. No. 5,539,345 to Hawkins (1996) described a system to synchronize clock signals between two processors having independent and differing clock signals for the purposes of reliable data transfer.

Although different systems have been proposed to provide efficient operation for embedded microprocessor applications, a need exists for an efficient, independent system having enhanced latency and fault tolerant operating capabilities and general input/output facilities suitable for low power memory applications.

### SUMMARY OF THE INVENTION

The invention provides a programmable system-on-chip embedded processor system for supporting general input/output applications. The system comprises a modular, multiple bit, multithread processor core operable by at least four parallel and independent application threads sharing common execution logic segmented into a multiple stage processor pipeline wherein the processor core is capable of having at least two states, a logic mechanism engaged with the processor core for executing an instruction set within the processor core to generate instruction state data, a supervisory control unit controlled by at least one of the processor core threads for examining the core processor state and for controlling the core processor operation, at least one memory for storing and executing the instruction set data and for storing system values, and a peripheral adaptor engaged with the processor core for transmitting input/output signals to and from the processor core.

The invention uses an innovative, low gate latency embedded processor and peripheral logic design that can be implemented in various integrated circuit technologies. This design can include programmable clock technology, thread-level monitoring capability and thread-driven power management features.

### BRIEF DESCRIPTION OF THE DRAWINGS

FIG. 1 illustrates a schematic view of a multithread processor for embedded applications.

FIG. 2 illustrates a master clock adaptor mechanism.

FIG. 3 illustrates up to eight supervisory control registers subject to read and write operations.

FIG. 4 illustrates a block diagram showing processing for up to eight pipeline stages.

FIG. 5 illustrates a chart showing progression of threads through a processor pipeline.

FIG. 6 illustrates potential operating characteristics of a thread processor.

FIG. 7 illustrates a representative access pointer.

FIG. 8 illustrates a representative machine instruction set.

FIG. 9 illustrates representative processor address modes.

### DESCRIPTION OF THE PREFERRED EMBODIMENTS

The invention uniquely embeds a complete, independent, processing system with general input/output capability within either logic-optimized or memory-optimized process technologies. The invention diverges from conventional systems because the system architecture is applicable to implementations on logic-optimized and memory-optimized process technologies. The invention provides a platform for sampling, supervising and controlling the execution of multiple threads within a pipeline processor, thereby providing a powerful mechanism to direct and restrict operation of multiple concurrent threads competing for more general system resources.

The invention accomplishes these functions by using a pipelined architecture with a single processor/functional control unit wherein instructions take multiple processor cycles to execute but one instruction from an individual stream is typically executed each processor cycle. The invention provides a simple platform for sampling, supervising and controlling the execution of multiple threads within a pipeline processor not through separate specialized hardware and memory registers but through the control of any of the pipeline processor threads. This supervisory control function can also incorporate a hardware semaphore mechanism to control access to a set of program-defined resources including memory, registers and peripheral devices.

The invention also uses a software based watchdog mechanism applicable to multi-threaded, pipelined processors which provides unique capacity for inter-thread monitoring and correction. This feature of the invention is useful for monitoring and testing the system as it is ported to new process technologies and for use in mission critical systems. “Multithreading” defines the capability of a microprocessor to execute different parts of a system program (“threads”) simultaneously, and can be achieved with software or hardware systems. Multithreading with a single processor core can be achieved by dividing the execution time of the processor core so that separate threads execute in segmented time windows, by pipelining multiple concurrent threads, or by running multiple processors in parallel. A microprocessor preferably has the ability to execute a single instruction on multiple data sets (“SIMD”) and multiple instructions on multiple data sets (“MIMD”). Multiple threads are executed in parallel using a pipelined architecture and shared processor logic. By using a pipelined architecture the stages of fetching, decoding, processing, memory and peripheral accesses and storing machine instructions are separated and parallel threads are introduced in a staggered fashion into the pipeline. At any time during pipeline execution each separate thread machine instruction is at a different stage in the pipeline so that within any cycle of the processor logical operations for “n” such threads are processed concurrently. On average one complete machine instruction is completed per clock cycle from one of the active threads. The invention provides significant processing gain and supervisory functions using less than 100,000 transistors instead of the tens of millions of transistors found in non-embedded microprocessors. This design also minimizes the number of gates in any logic chain. By breaking instruction processing up into 8 simplified stages the complexity and hence logic chain depth of each stage is reduced. The design thus minimizes the effect of gate switching latency and facilitates the invention's portability to various integrated circuit technologies.

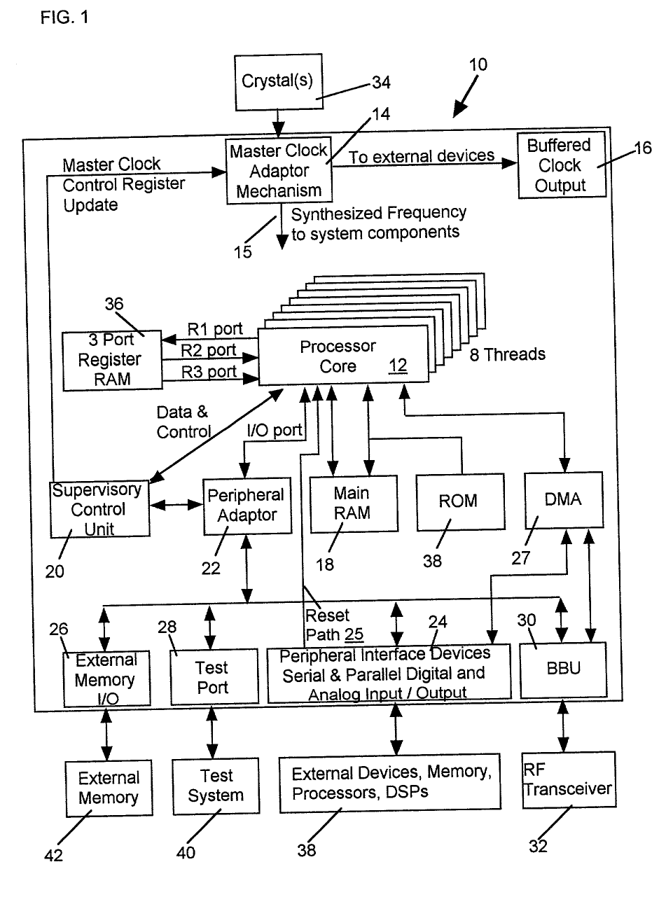

Referring to FIG. 1, single-chip embedded processor 10 has input/output capabilities comprising a central eight thread processor core 12, master clock adaptor mechanism 14 with synthesized frequency output 15, buffered clock output 16, internal memory components shown as main RAM 18 (and ROM 38), supervisory control unit (“SCU”) 20, peripheral adaptor 22, peripheral interface devices 24, external memory interface 26, direct memory access (“DMA”) controller 27, and test port 28. The system provides various embedded input/output applications such as baseband processor unit (“BBU”) 30 connected to radio frequency (“RF”) transceiver 32 for communications applications and also as an embedded device controller.

As shown in FIG. 1 the system, as implemented as an application specific integrated circuit (“ASIC”) or in memory technologies, is contained within a box identified as processor 10. A central component in processor 10 is multithread processor core 12 illustrated as an eight-stage pipeline capable of executing eight concurrent program threads in a preferred embodiment of the invention. All elements within processor 10 are synchronized to master clock adaptor mechanism 14 for receiving a base timing signal from crystal 34. Master clock adaptor mechanism 14 is used internally for synchronizing system components and is also buffered externally as a potential clock output 16 to another system. A second clock input can be fed to buffered output 16 so that a system working with processor 10 can have a different clock rate.

Connected to processor core 12 are various types of memory. A three port register RAM module 36 comprising eight sets of eight words is used for registers R0 to R7 for each of the eight processor threads. A boot ROM memory 38 can store several non- volatile programs and data including the system boot image and various application specific tables such as a code table for RF transceiver 32 applications. Test system 40 is engaged with test port 28 and external memory 42 is engaged with external memory input/output (i/o) interface 26. When the system starts up the boot ROM 38 image is copied into main RAM 18 for execution. Temporary variables and other modifiable parameters and system data are also stored in main RAM 18. Main RAM 18 can be structured in a two port format. If additional memory is required, external memory 42 can be accessed through peripheral adaptor 22 using input/output instructions.

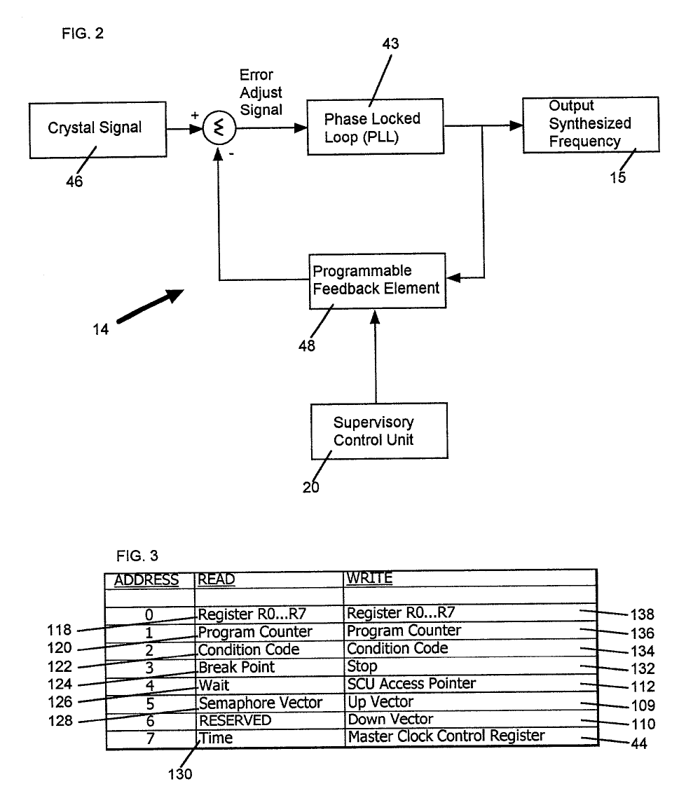

Referring to FIG. 2, master clock adaptor mechanism 14 is programmable by a supervisory control unit 20 engaged with a master clock control register 44 (see FIG. 3) which controls the synthesized frequency output 15 of master clock adaptor mechanism 14. Crystal signal 46 from external crystal 34 acts as a timing input reference to processor 10 from which synthesized frequency output 15 is derived. Master clock adaptor mechanism 14 is capable of upward or downward adjustments of synthesized frequency output 15 by adjusting a programmable feedback element 48 value found in the feedback loop of phase locked loop feedback circuit 43. Any system thread can make this adjustment through supervisory control unit master clock control register 44. Although master clock adaptor mechanism 14 is preferably constructed from phase locked loop feedback circuit 43, it may be implemented with any equivalent programmable technology. Similarly, although master clock adaptor mechanism 14 is shown to be integrated within processor 10, it may be alternatively located external to processor 10 and programmed through one of the digital input/output peripheral interface devices 24 by one of the processor 10 threads.

Master clock adaptor mechanism 14 is useful in several regards. When used in combination with a nonvolatile external memory 42 located outside processor 10 it can be used to reduce the cost of crystal 34. Less expensive crystals are less precise and have greater variations in their reference frequency between individual crystal samples. This becomes an issue in mass-produced devices, where precise operating frequencies are required e.g. for interfaces such as USB (universal serial bus) and various radio frequency communication links requiring precise frequency values to maintain synchronization with remote systems. In conventional system implementations more precise crystals need to be used at significantly higher price. With the invention a method is proposed wherein a lower cost crystal can be used with equivalent accuracy. This is done by creating a manufacturing test apparatus that contains a very precise and expensive crystal clock source and comparing this crystal reference to each device containing the processor 10 as it is manufactured. The manufacturing test apparatus can then selectively write frequency difference information in a known memory location in non-volatile external memory 42. Upon boot up the processor 10 firmware found in ROM 38 directs the processor 10 to read this difference information and uses it to program the master clock adaptor mechanism 14 through the supervisory control unit master clock control register 44. Even though the external crystal frequency may not meet specifications, the internal clock signal can be adjusted to be substantially at the specified value. Thus a very inexpensive crystal can be used for very precise frequency control at a substantial cost savings.

Programmability of the master clock adaptor mechanism can also be used to dynamically adjust the device clock frequency during operation. This can be used to change the internal clock rate to compensate for crystal operational variations such as drift due to heating or other effects. It can also be used to adjust processor 10 internal clock with respect to an external timing reference as derived from inputs to processor 10. For example, BBU 30 can derive an external device clock reference signal from its communication interface and this can be used to change the processor 10 internal clock rate.

Master clock adaptor mechanism 14 is also useful for general frequency scaling purposes and may have one or more crystal inputs and outputs for various processor 10 purposes such as processor operation at a different frequency than buffered clock output 16. The processor frequency may be reduced selectively to lower device power consumption during idle times and increased to a reference value during times of higher activity. This can be done uniquely by any one or more of processor 10 threads through master clock control register 44 identified in supervisory control unit 20. This flexibility also contributes to design portability between different integrated circuit technologies since the clock rate can be adjusted by firmware to adapt to a given technology having certain operating frequency characteristics such as a slower FLASH memory-based versus DRAM-based integrated circuit process technologies. This can be done without altering the design of circuitry of a reference design external to processor 10. This feature of the invention is particularly useful when testing an implementation of processor 10 in a new integrated circuit process technology. The operating frequency can be varied dynamically to assess the impact of different operating frequencies on various elements of the new implementation.

Supervisory control unit 20 can be configured as a special purpose peripheral to work integrally with processor core 12 through peripheral adaptor 22. A “controlling” thread in processor core 12 issues input/output instructions to access supervisory control unit 20 by peripheral adaptor 22. Any of the threads can function as the controlling thread. Supervisory control unit 20 accesses various elements of processor core 12 as supervisory control unit 20 performs supervisory control functions. Supervisory control unit 20 is capable of supporting various supervisory control functions including: 1) a run/stop control for each thread processor, 2) read/write access to the private state of each thread processor, 3) detection of unusual conditions such as I/O lock ups, tight loops, 4) semaphore-based management of critical resources, and 5) a sixteen-bit timer facility, referenced to master clock adaptor mechanism 14 for timing processor events or sequences. During normal processing supervisory control unit 20 reads state information from the processor pipeline without impacting thread processing. Supervisory control unit 20 will only interrupt or redirect the execution of a program for a given thread when directed to by a controlling thread.

In one embodiment supervisory control unit 20 can manage access to system resources through a sixteen bit semaphore vector. Each bit of the semaphore controls access to a system resource such as a memory location or range or a peripheral address, a complete peripheral, or a group of peripherals. The meaning of each bit is defined by the programmer in constants set in ROM 38 image. ROM 38 may be of FLASH type or processor 10 threads may access this information from an external memory, thus allowing the meaning of the bits of the semaphore vector to change depending on the application. A thread reserves a given system resource by setting the corresponding bit to “1”. Once a thread has completed using a system resource it sets the corresponding bit back to “0”. Semaphore bits are set and cleared using the “Up Vector” register 109 and “Down Vector” register 110 shown in FIG. 3.

Peripheral adaptor 22 accesses various generic input/output interface devices 24 which can include general purpose serial interfaces, general purpose parallel digital input/output interfaces, analog-to-digital converters, digital-to-analog converters, a special purpose baseband unit (“BBU”) 30, and test port 28. Baseband unit 30 is used for communications applications where control signals and raw serial data are passed to and from radio frequency (“RF”) transceiver 32. Baseband unit 30 synchronizes these communications and converts the stream to and from serial (to RF transceiver 32) to parallel format used by processor core 12. Test port 28 can be used for development purposes and manufacturing testing. Test port 28 is supported by a program thread running on processor core 12 that performs various testing functions such as starting and stopping threads using supervisory control unit 20. A general reset function can also be implemented using reset path 25. If one of the digital input/output interfaces of generic input/output devices 24 is connected, internally or externally, to the reset path 25 (or pin for external connection) of processor 10, any thread that is running on processor 10 can reset the entire system by setting the appropriate digital output bit.

The ASIC supports a multiple-thread architecture with a shared memory model. The programming model for processor core 12 is equivalent to a symmetric multiprocessor (“SMP”) with eight threads, however the hardware complexity is comparable to that of a simple conventional microprocessor with input/output functions. Only the register set is replicated between threads.

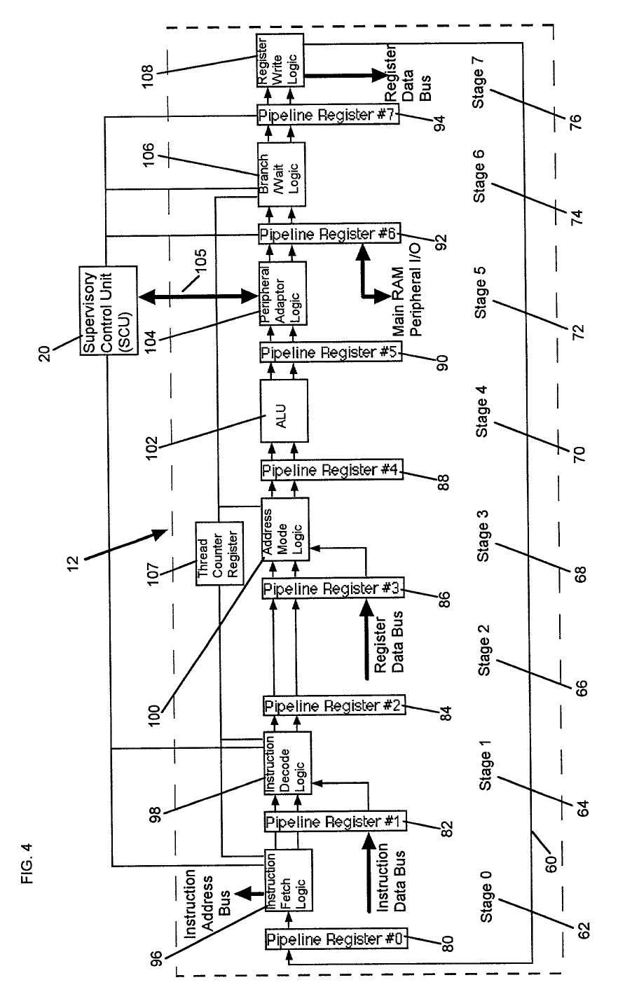

Processor core 12, shown in FIG. 4, employs synchronous pipelining techniques known in the art to efficiently process multiple threads concurrently. In one embodiment of the invention as illustrated, a typical single sixteen-bit instruction is executed in an eight-stage process. Where instructions consist of two sixteen-bit words, two passes through the pipeline stage are typically required. The eight stages of the pipeline include:

| | |
|---|---|
| Stage 0 | Instruction Fetch |
| Stage 1 | Instruction Decode |
| Stage 2 | Register Reads |
| Stage 3 | Address Modes |
| Stage 4 | ALU Operation |
| Stage 5 | Memory or I/O Cycle |
| Stage 6 | Branch/Wait |
| Stage 7 | Register Write |

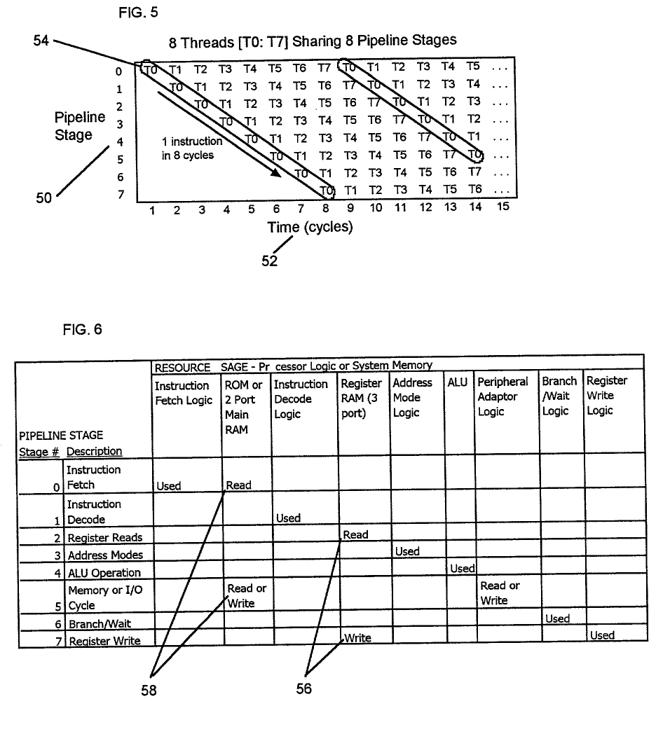

There are several significant advantages to this pipelining approach. First, instruction processing is broken into simple, energy-efficient steps. Second, pipelined processing stages can be shared by multiple threads. Each thread is executing in parallel but at different stages in the pipeline process as shown in FIG. 5. Vertical axis 50 in FIG. 5 denotes the pipeline stage and horizontal axis 52 corresponds to processor master clock adaptor mechanism 14 cycles or time. Although each instruction per thread takes eight clock cycles to execute, on average the pipeline completes one instruction per clock cycle from one of the executing eight threads. Accordingly, the pipelined architecture provides significant processing gain. Third, because each of the pipeline threads can be executed independently, real-time critical tasks can be dedicated to separate threads to ensure their reliable execution. This feature of the invention is much simpler and more reliable than traditional interrupt-driven microprocessors where complex division of clock cycles between competing tasks is difficult to prove and implement reliably.

On each cycle of processor master clock adaptor mechanism 14 output the active instruction advances to the next stage. Following Stage 7, the next instruction in sequence begins with Stage 0. As seen in FIG. 5, thread 0 (T0) enters the pipeline Stage 0 in cycle “1” as shown by 54. As time progresses through the clock cycles, T0 moves through Stages 0 to Stages 7 of the pipeline. Similarly, other threads T1 to T7 enter the pipeline Stage 0 in subsequent cycles “1” to cycles “8” and move through Stages 0 to Stages 7 as shown in FIG. 5 as T0 vacates a particular Stage. The result of this hardware-sharing regime is equivalent to eight thread processors operating concurrently.

As seen in FIG. 6, on each tick of processor master clock 14 two sixteen bit registers are read and one sixteen bit register 56 may be written. Since the reads are performed in Stage 2 (shown as 66 in FIG. 4), whereas the optional write is performed in Stage 7 (shown as 76 in FIG. 4), the reads always pertain to a different thread than the write. Because the register subset for each thread is distinct, there is no possibility of collision between the write access and the two read accesses within a single clock tick.

Referring to FIG. 4, processor core 12 pipeline supports thirty-two bit instructions such as two-word instruction formats. Each word of an instruction passes through all eight pipeline stages so that a two-word instruction requires sixteen clock ticks to process. Line 60 joins the Register Write Logic 108 in Stage 7 (shown as 76) of the pipeline to the Pipeline Register #0 (shown as 80) in Stage 0 (shown as 62). In general, each thread processes one word of instruction stream per eight ticks of processor master clock adaptor mechanism 14.

The private state of each thread processor 12, as stored in the pipeline registers #0 to #7 (shown as 80 to 94 in FIG. 4) or the three-port RAM 36 module (registers 0 to 7, R0:R7), comprises the following: 1) a sixteen bit program counter (PC) register; 2) a four bit condition code (CC) register, with bits named n, z, v, and c; 3) a set of eight sixteen bit general purpose registers (R0:R7); and 4) flags, buffers and temporary registers at each pipeline stage. Physically the general-purpose registers can be implemented as a sixty-four-word block in three-port RAM module 36 as seen in FIG. 1. Register addresses are formed by the concatenation of the three bit thread number (T0:T7) derived from the thread counter register, together with a three bit register specifier (R0:R7) from the instruction word. A single sixteen bit instruction can specify up to three register operands.

As an instruction progresses through the hardware pipeline shown in FIG. 4, the private state of each thread processor is stored in a packet structure which flows through the processor pipeline, and where the registers (R0:R7) are stored in the three-port, sixty-four word register RAM 36 and the other private values are stored in the Pipeline Registers #0 to #7 (shown as 80 to 94). The thread packet structure is different for each pipeline stage, reflecting the differing requirements of the stages. The size of the thread packet varies from forty-five bits to one hundred and three bits.

Referring to FIG. 6, all eight threads have shared access to main RAM 18 and to the full peripheral set. Generally speaking threads communicate with one another through main RAM 18, although given thread can determine the state of and change the state of another thread using supervisory control unit 20. In Stage 0 (shown as 62) and Stage 5 (shown as 72) two-port main RAM 18 is accessed by two different threads executing programs in different areas in main RAM 18 as shown by 58 in FIG. 6. If a given block of main RAM 18 is not being accessed by a processor 10 thread, the direct memory access (DMA) controller 27 is allowed to transfer data to and from memory from system peripherals. DMA controller 27 is accessed through the peripheral adaptor 22 indirectly through peripheral interface device 24 or BBU 30.

Referring to FIG. 4 which illustrates the pipeline mechanism, the various pipeline stages and supervisory control unit 20 and thread counter 107 inter-working with core processor 12 pipeline is shown. Thread counter 107 directs the loading of state information for a particular thread into Stage 0 (shown as 62) of the pipeline and counts from 0 to 7 continuously. An instruction for a particular thread, as directed by thread counter 107, enters the pipeline through Pipeline Register #0 (shown as 80) at the beginning of Stage 0 (shown as 62). Instruction Fetch Logic 96 accesses main RAM 18 address bus and the resultant instruction data is stored in Pipeline Register #1 (shown as 82). In Stage 1 (shown as 64) the instruction is decoded. In Stage 2 (shown as 66) this information is used to retrieve data from the registers associated with the given thread currently active in this stage. In Stage 3 (shown as 68) Address Mode Logic 100 determines the addressing type and performs addressing unifications (collecting addressing fields for immediate, base displacement, register indirect and absolute addressing formats for various machine instruction types). In Stage 4 (shown as 70), containing ALU 102 and associated logic, ALU 102 performs operations such as for address or arithmetic adds, sets early condition codes, and prepares for memory and peripheral I/O operations of Stage 5 (shown as 72).

For branches and memory operations, ALU 102 performs address arithmetic, either PC relative or base displacement. Stage 5 (shown as 72) accesses main RAM 18 or peripherals (through Peripheral Adaptor Logic 104) to perform read or write operations. Stage 6 (shown as 74) uses Branch/Wait logic 106 to execute branch instructions and peripheral I/O waits. In some circumstances, a first thread will wait for peripheral device 24 to respond for numerous cycles. This “waiting” can be detected by a second thread that accesses an appropriate supervisory control unit 20 register. The second thread can also utilize supervisory control unit 20 register timer which is continuously counting to determine the duration of the wait. If a peripheral device 24 does not respond within a given period of time, the second thread can take actions to re-initialize the first thread as it may be stuck in a wait loop. Stage 7 (shown as 76) writes any register values to three port register RAM module 36. The balance of the thread packet is then copied to Pipeline Register #0 (shown as 80) for the next instruction word entering the pipeline for the current thread.

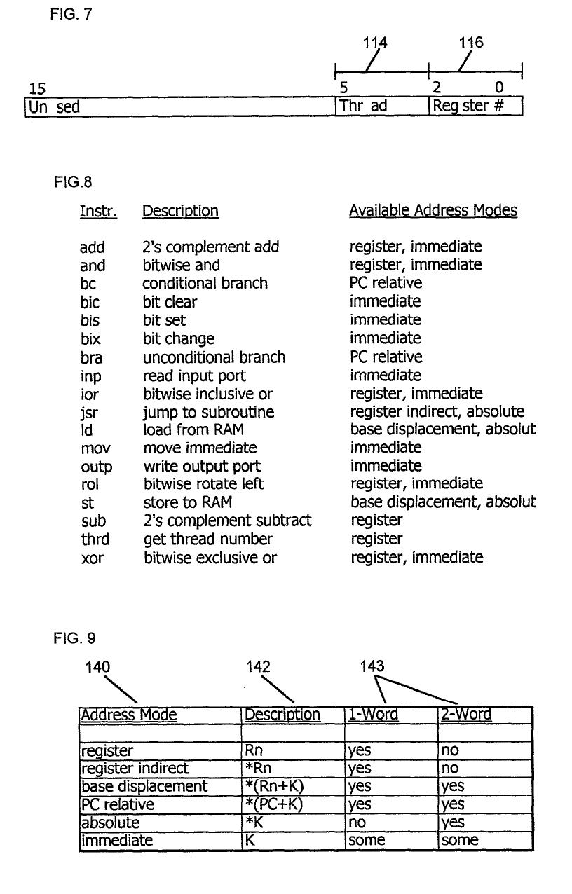

FIG. 4 also shows supervisory control unit 20 used to monitor the state of the processor core threads, control access to system resources, change the internal clock frequency (for implementations where the master clock adaptor mechanism is internal to processor 10) and in certain circumstances to control the operation of threads. Supervisory control unit 20 can selectively read or write state information at various points in the pipeline hardware as illustrated in FIG. 4. It is not a specialized control mechanism that is operated by separate control programs but is integrally and flexibly controlled by any of the threads of processor core 12. Supervisory control unit 20 is configured as a peripheral so it is accessible by any thread using standard input/output instructions through the peripheral adaptor logic 104 as indicated by the thick arrow 105 in FIG. 4. The formats of these instructions “inp” and “outp” are described below. When a given thread wishes to direct a thread-specific supervisory control unit 20 operation, it must first write a pointer value to input/output address “4” (shown as 112) as is shown in FIG. 3. Pointer 112 contains the thread being accessed by supervisory control unit 20 in bit locations “3” to “5” (shown as 114) as shown in FIG. 7. If a register is accessed through an supervisory control unit 20 operation, the value of the desired register is contained in bits “0” to “2” (shown as 116) of the pointer.

Various supervisory control unit 20 read and write operations are supported. Read accesses (“inp” instruction) have no affect on the state of the thread being read. As shown in FIG. 3, register values (R0:R7), program counter values, condition code values, a breakpoint (tight loop in which a thread branches to itself) condition for a given thread, a wait state (thread waiting for a peripheral to respond) for a given thread, a semaphore vector value and a continuously running sixteen bit counter can be read. A “breakpoint” register 124 detects if a thread is branching to itself continuously. A “wait” register 126 tells if a given thread is waiting for a peripheral, such as when a value is not immediately available. A “time” register 130 is used by a thread to calculate relative elapsed time for any purpose such as measuring the response time of a peripheral in terms of the number of system clock cycles. By convention a given target thread should be “stopped” before any write access (“outp” instruction) is performed on its state values. If a controlling thread desires to change a register, program counter or condition code for a given target thread, the controlling thread must first “stop” the target thread by writing a word to stop address “3” (shown as 132) as seen in FIG. 3. Bit “0” to bit “7” of the stop vector correspond to the eight threads of processor core 12. By setting the bit corresponding to the target thread to one, this causes the target thread to complete its current instruction execution through the pipeline. The pipeline logic then does not load any further instructions for that thread until the target thread's bit in the stop vector is once again set to zero by the controlling thread, such as in a “run” operation. Once the target thread is stopped the controlling thread can then write to any register l value (shown as 138), the program counter (shown as 136) or the condition codes (shown as 134) of the target thread by performing a write (“outp” instruction) to an appropriate supervisory control unit 20 input/output address location as shown in FIG. 3.

The “stopping” a thread feature is useful not only in reconfiguring processor core 12 to modify the target thread's execution flow but also to conserve processor 10 power. When a thread is “stopped” the sense amplifier, used to access the RAM memory associated with the “stopped” thread, is disabled, saving system power. The contents of the memory are retained even though access to it has been cut off.

Also shown in the “write” column of FIG. 3, an Up Vector 109 and a Down Vector 110 are used to respectively reserve and free up resources using a supervisory control unit hardware semaphore. The value of the semaphore can be read at any time by a given thread (address 5, Semaphore Vector 128) to see what system resources have been locked by another thread. Each thread is responsible for unlocking a given resource using Down Vector register 110 when it is done with that resource.

Processor core 12 supports a set of programming instructions also referred to as “machine language” or “machine instructions”, to direct various processing operations. This instruction set is closely tied to a condition code mechanism. Processor core 12 machine language comprises eighteen instructions as shown in FIG. 8 and a total of six address modes shown in FIG. 9. Machine instructions are either one or two words in size. Two word instructions must pass through the pipeline twice to complete their execution one word-part at a time. The table shown in FIG. 9 describes the six address modes 140, provides a symbolic description 142, and gives the instruction formats 143 to which they apply by instruction size. Results written to a register by one instruction are available as source operands to a subsequent instruction. The machine language instructions of the invention can be used in combination to construct higher-level operations. For example, the bitwise rotate left instruction, combined with the bit clear instruction, gives a shift left operation where bits are discarded as they are shifted past the most significant bit position.

A series of conventions can be used to describe the machine instruction set and related processor registers. R0 . . . R7 are defined as register “0” to register “7” respectively. “Rn” is used to refer to registers in general, and “rn” is used for a particular register instance. “PC” is the program counter. “CC” is a condition code register. “K” refers to a literal constant value. For one-word instruction formats, the precision of “K” is limited to between four and eight bits. For the two-word instruction formats, “K” is specified by sixteen bits such as the second word of the instruction. “T” is a temporary register. “*” is a pointer to a value in memory. “&” is an AND logical operation. “|” is an OR logical operation. “ˆ ” is an exclusive OR logical operation. “!” is a NOT logical operation. “<<” is a shift left operation. A separate register set, program counter and condition code register is kept for each system thread. The “n”, “z”, “v” and “c” bits of the condition code (“CC”) register have different interpretations, depending on the instruction that produced them. For arithmetic operations, add and subtract, the CC bits respectively mean negative, zero, overflow, and carry. For other operations, the “c” bit means character such as the result in an interval 1 to 255. The “v” bit has varying interpretations, usually indicating that the result is odd. Details of the instruction set are shown later. “msb” is an abbreviation for most significant bit. “lsb” is an abbreviation for least significant bit, or bit 0 when the word is read from right to left.

In fault tolerant systems, a watchdog mechanism is put in place to ensure that a given thread or entire processor is operating properly. In a conventional implementation a watchdog timer is used, where this timer continually counts down or up. If the timer hits zero or overflows (depending on whether it is counting down or up) before the processor re-initializes it, the system will be reset. This is done so that if the system ever locks up it can be reset and begin operation again from a clean state. For mission critical systems this is often a standard feature and is also a useful feature when developing new hardware implementations.

A sophisticated watchdog mechanism is used by the invention. Using SCU 20 time register 130 or by inherent knowledge of one thread of another thread's program functions, a software watchdog mechanism can operate. In one approach, each of the threads can periodically read the time register 130 and store the result in a known main RAM 18 location associated with that thread. One or more system threads can read the timer values from one or more other threads to determine if a given thread is hung up by detecting if the count value changes over time. If a thread is hung up, the detecting thread can stop the hung thread, re-point its program counter it to its boot up starting point, and then start it running again. In this way it can be re-initialized and begin operating from a clean state.

In another approach, a more sophisticated state record can be stored by a first system thread and read by another system thread. The mechanism can be the same as using the time register 130, such as where one or more threads checks one or more other threads, but the level of sophistication can be greater. For example, if a first thread is continuously buffering input from a peripheral, such as a varying incoming serial bit stream, a second thread could read the serial bit stream buffer. If it sees that the buffer does not change for a reasonable amount of time it might be inferred, subject to the characteristics of the particular application, that the first thread is in some way hung up and is unable to make updates. More detailed state information might be gathered from the first thread to clear the problem without a restart or the first thread could be immediately restarted to clear the problem. The above example has the added advantage that the first thread expends no processing time indicating its state to the second thread, such as in the time register 130 approach where the first thread would need to read a time value and then store it in a known memory location.

The relationship between monitoring and monitored threads can be statically assigned or dynamically determined. For example, in one embodiment of the invention, for a system containing eight threads, each thread might be statically programmed to monitor the state of the next higher thread, and the eighth thread monitors the first thread. If a given thread fails, the next previous thread will detect the failure and restart the failed thread.

In another implementation only a few threads would perform the monitoring function. An algorithm could be implemented to dynamically control the thread or threads actively monitoring other system threads. A first thread can monitor all other threads using a timer or state-based monitoring techniques for a period of time and then pass along the responsibility to a second or subsequent thread. This might be implemented using a state variable modification technique. If each thread in the system has a “monitoring” flag variable, the actively monitoring thread can have its flag set to true. Each thread in the system could have a “monitor” test branch condition tested periodically to see if the given thread had been assigned the role of system monitor. Upon a transition of monitoring responsibilities to a second thread, the first thread would ensure the second thread was operating properly, set its “monitoring” flag to false and then set the second thread's “monitoring” flag to true. When the second thread checks its “monitor” test branch condition it identifies the flag state change and begins the “monitoring” role for a defined period of time. This method or similar circulating method would allow for the role of the monitor to change dynamically.

Monitoring can use more than one active “monitoring” thread. In this implementation, the “monitoring” threads would be cross-checking each other to ensure that a “monitoring” thread did not inadvertently stop functioning. In this way multiple-redundant layers of monitoring can be built up. Further software thread monitoring can be applied to configurations of multiple processors 10 sharing common memory in increasingly parallel implementations within limits or reasonable memory contention and access arbitration mechanisms.

Representative machine instructions can be described as follows:

R1...R3 represent any of the registers r0 to r7. The lower case
representation is used for actual machine instructions.
Instruction: “add” - 2's Complement Add

Format 1 - register: R1=R2+R3

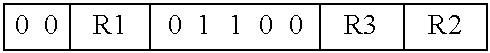

Format 2 - immediate K3=[−128:127]: R1=R2+K3

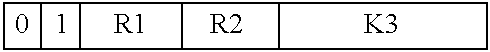

Format 3 - immediate: R1=R2+K3

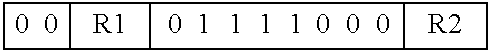

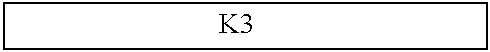

Instruction Fields:

| | |
|---|---|
| R1 | 3-bit specifier for destination register |
| R2 | 3-bit specifier for source register |
| R3 | 3-bit specifier for source register |
| K3 | signed 8-bit or 16-bit literal source |

Condition Codes:

| | |
|---|---|
| n | Set if result is negative, i.e. msb is 1 |
| z | Set if result is zero |
| v | Set if an overflow is generated |
| c | Set if a carry is generated |

Description:

Add the source operands and write the result to the
destination register R1.

Example Instructions:

| | |
|---|---|
| add | r1, r2, r3 (format 1) |
| add | r1, r2, 9 (formats 2 and 3) |

Instruction: “and” - Bitwise And

Format 1 - register: R1=R2&R3

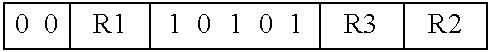

Format 2 - immediate: R1=R2&K3

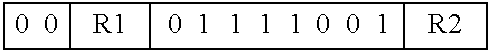

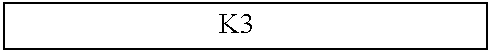

Instruction Fields:

| | |
|---|---|
| R1 | 3-bit specifier for destination register |
| R2 | 3-bit specifier for source register |
| R3 | 3-bit specifier for source register |
| K3 | 16-bit literal source |

Condition Codes:

| | |
|---|---|
| n | Set if result is negative, i.e. msb is 1 |
| z | Set if result is zero |
| v | Set if (R2 \| R3) != R3, or alternatively if (R2 \| |
| | K3) !=K3 |
| c | Set if result is in the interval [1:255] |

Description:

Bitwise-and the source operands and write the result to
the destination register R1.

Example Instructions:

| | |
|---|---|
| and | r1, r2, r3 (format 1) |
| and | r1, r2, 0x0F (format 2) |

Instruction: “bc” - Conditional Branch

Format 1 - PC relative K2=[−128:127]: if (condition(C1))
PC=PC+K2

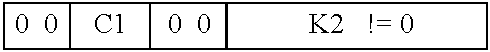

Format 2 - PC relative: if (condition(C1)) PC=PC+K2

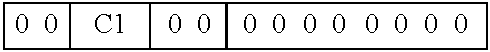

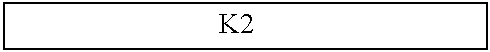

Instruction Fields:

| | |
|---|---|
| C1 | 4-bit specifier for branch condition |
| K2 | signed 8-bit or 16-bit literal source |

| Condition Codes: | | | | |
|---|---|---|---|---|
| C1 | Condition | | Signed | Unsigned |
| Value | (C1) | Test | Comparison | Comparison |
| 0x0 | C | | | < |
| 0x1 | V | | | |
| 0x2 | Z | ==0 | == | == |
| 0x3 | N | <0 | | |
| 0x4 | C \| z | | | <= |
| 0x5 | N \hat{ } v | | < | |
| 0x6 | (n\hat{ }v) \| z | | <= | |
| 0x7 | N \| z | <=0 | | |
| 0x8 | !c | | | >= |
| 0x9 | !v | | | |
| 0xA | !z | !=0 | != | != |
| 0xB | !n | >=0 | | |
| 0xC | ! (c \| z) | | | > |
| 0xD | ! (n \hat{ } v) | | >= | |
| 0xE | ! | | > | |
| 0xF | ! (n \| z) | >0 | | |

Description:

Evaluate the specified branch condition (C1) using the
n, z, v, and c bits of the condition code (CC) register
(see condition code table for values) . If the specified
branch condition is met, add the source operand to the
program counter (PC) register. Otherwise the program
counter is not affected.

Example Instruction:

| | |
|---|---|
| bc | 0x2, loopback (format 1 & 2) |

Instruction: “bic” - Bit Clear

Format 1 - immediate K3=[0:15]: R1=R2 & ˜(1<<K3)

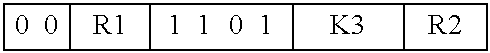

Instruction Fields:

| | |
|---|---|
| R1 | 3-bit specifier for destination register |
| R2 | 3-bit specifier for source register |
| K3 | 4-bit literal source |

Condition Codes:

| | |
|---|---|
| n | Set if result is negative, i.e. msb is 1 |
| z | Set if result is zero |
| v | Set if the selected bit was 1 when it was tested |
| c | Set if result is in the interval [1:255] |

Description:

Select a single bit of the source operand R2 using the
immediate operand K3, test the selected bit, clear the
selected bit, and write the result to the destination
register R1. The bits of R2 are numbered 15:0, with bit
0 the least significant bit.

Example Instruction:

| | |
|---|---|
| bic | r1, r2, 3 (format 1) |

Instruction: “bis” - Bit Set

Format 1 - immediate K3=[0:15]: R1=R2 | (1<<K3)

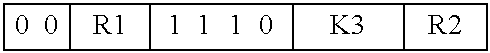

Instruction Fields:

| | |
|---|---|
| R1 | 3-bit specifier for destination register |
| R2 | 3-bit specifier for source register |
| K3 | 4-bit literal source |

Condition Codes:

| | |
|---|---|
| n | Set if result is negative, i.e. msb is 1 |
| z | Set if result is zero |
| v | Set if the selected bit was 1 when it was tested |
| c | Set if result is in the interval [1:255] |

Description:

Select a single bit of the source operand R2 using the
immediate operand K3, test the selected bit, set the
selected bit, and write the result to the destination
register R1. The bits of R2 are numbered 15:0, with bit
0 the least significant bit.

Example Instruction:

| | |
|---|---|
| bis | r1, r2, 3 (format 1) |

Instruction: “bix” - Bit Change

Format 1 - immediate K3=[0:15]: R1=R2 \hat{ } (1<<K3)

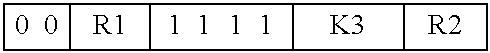

Instruction Fields:

| | |
|---|---|
| R1 | 3-bit specifier for destination register |
| R2 | 3-bit specifier for source register |
| K3 | 4-bit literal source |

Condition Codes:

| | |
|---|---|
| n | Set if result is negative, i.e. msb is 1 |
| z | Set if result is zero |
| v | Set if the selected bit was 1 when it was tested |
| c | Set if result is in the interval [1:255] |

Description:

Select a single bit of the source operand R2 using the
immediate operand K3, test the selected bit, change the
selected bit, and write the result to the destination
register R1. The bits of R2 are numbered 15:0, with bit
0 the least significant bit.

Example Instruction:

bix r1, r2, 3 (format 1)

Instruction: “bra” - Unconditional Branch

Format 1 - PC relative K1=[−128:127]: PC=PC+K1

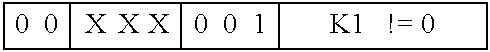

Format 2 - PC relative: PC=PC+K1

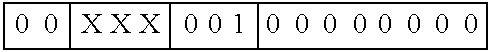

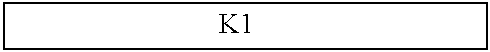

Instruction Fields:

| | |
|---|---|
| K1 | signed 8-bit or 16-bit literal source |

Condition Codes:

Not affected

Description:

Add the source operand to the program counter (PC)
register. “X” is don't care.

Example Instruction:

bra branchstart1 (format 1 & 2)

Instruction: “inp” - Read Input Port of Peripheral

Format 1 - immediate K2=[0:127]: PC=PC+K1

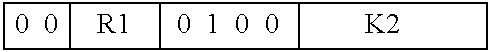

Instruction Fields:

| | |
|---|---|
| R1 | 3-bit specifier for destination register |
| K2 | unsigned 7-bit literal source |

Condition Codes:

| | |
|---|---|
| n | Set if result is negative, i.e. msb is 1 |
| z | Set if result is zero |
| v | Set if result is odd, i.e. lsb is 1 |
| c | Set if result is in the interval [1:255] |

Description:

Read the input port at I/O address K2 and write the
result to the destination register R1.

Example Instruction:

| | |
|---|---|
| inp | r1, 0x00 (format 1) |

Instruction: “ior” - Bitwise Inclusive Or

Format 1 - register: R1=R2|R3

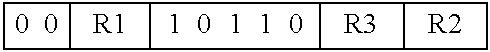

Format 2 - immediate: R1=R2|K3

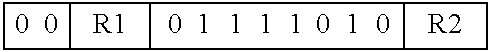

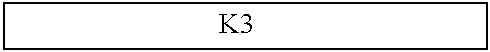

Instruction Fields:

| | |
|---|---|
| R1 | 3-bit specifier for destination register |
| R2 | 3-bit specifier for source register |
| R3 | 3-bit specifier for source register |
| K3 | 16-bit literal source |

Condition Codes:

| n | Set if result is negative, i.e. msb is 1 |
|---|---|
| z | Set if result is zero |
| v | Set if (R2 & P3) == R3, or alternatively if (R2 & |
| K3) == K3 | |
| c | Set if result is in the interval [1:255] |

Description:

Bitwise-inclusive-or the source operands and write the
result to the destination register R1.

Example Instructions

| | |
|---|---|
| ior | r1, r2, r3 (format 1) |
| ior | r1, r2, 0x1F (format 2) |

Instruction: “jsr” - Jump to Subroutine

Format 1 - register indirect with temporary T: T=R2; R1=PC;
PC=T

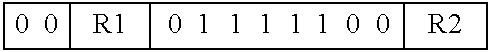

Format 2 - absolute: T=K2; R1=PC; PC=T

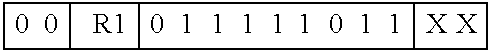

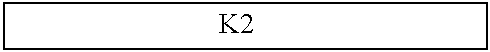

Instruction Fields:

| | |
|---|---|
| R1 | 3-bit specifier for destination register |
| R2 | 3-bit specifier for source register |
| K2 | 16-bit literal source |

Condition Codes:

Not affected

Description:

Save the source operand in a temporary T, write the
program counter (PC) to the destination register R1, and
write the temporary T to the program counter (PC)
register. “X” is don't care.

Example Instructions:

| | |
|---|---|
| jsr | r1, r2 (format 1) |
| jsr | r1, go_ahead (format 2) |

Instruction: “id” - Load from RAM

Format 1 - base displacement absolute indexed, K3=[−128:127]:
R1=*(R2+K3)

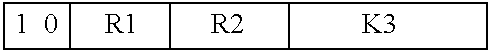

Format 2 - base displacement absolute indexed: R1=*(R2+K3)

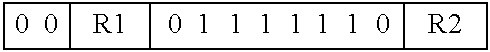

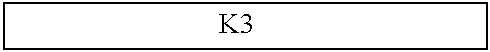

Format 3 - absolute: R1=*K2

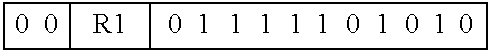

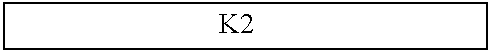

Instruction Fields:

| | |
|---|---|
| R1 | 3-bit specifier for destination register |
| R2 | 3-bit specifier for base register |
| K3 | signed 8-bit or 16-bit displacement |
| K2 | 16-bit absolute address |

Condition Codes:

| | |
|---|---|
| n | Set if result is negative, i.e. msb is 1 |
| z | Set if result is zero |
| v | Set if result is odd, i.e. lsb is 1 |
| c | Set if result is in the interval [1:255] |

Description:

For formats 1 and 2, add the base register R2 and the
displacement K3 to form the address of the RAM source.
For format 3, K2 is the address of the RAM source. Read
the RAM source and write the result to the destination
register R1. Note that absolute indexed is a synonym
for base displacement.

Example Instructions:

| | |
|---|---|
| ld | r1, r2, 0x1F (formats 1 & 2) |
| ld | r1, 0x2F (format 3) |

Instruction: “mov” - Move Immediate

Format 1 - immediate, K2=[−32:31]: R1=K2

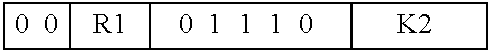

Format 2 - immediate: R1=K2

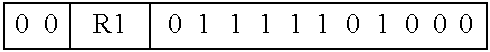

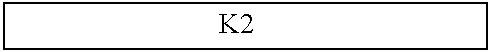

Instruction Fields:

| | |
|---|---|
| R1 | 3-bit specifier for destination register |
| K2 | signed 6-bit or 16-bit literal source |

Condition Codes:

Not affected

Description:

Write the source value K2 to the destination register
R1.

Example Instruction:

| | |
|---|---|
| mov | r1, 1 (formats 1 & 2) |

Instruction: “outp” - Write Output Port of Peripheral

Format 1 - immediate, K2=[0:127]: outp(R1,K2)

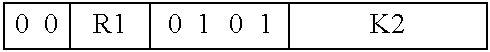

Instruction Fields:

| | |
|---|---|
| R1 | 3-bit specifier for source register |
| K2 | unsigned 7-bit literal source |

Condition Codes:

Not affected

Description:

Read the source operand R1 and write the result to the
output port at I/O address K2.

Example Instruction:

outp r1, SCUpc (format 1)

Instruction: “rol” - Bitwise Rotate Left

Format 1 - register: R1=R2<<R3

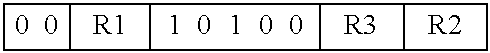

Format 2 - immediate, K3=[0:15]: R1=R2<<K3

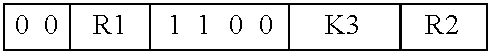

Instruction Fields:

| | |
|---|---|
| R1 | 3-bit specifier for destination register |
| R2 | 3-bit specifier for source register |
| R3 | 3-bit specifier for source register |
| K3 | 4-bit literal source |

Condition Codes:

| | |
|---|---|
| n | Set if result is negative, i.e. msb is 1 |
| z | Set if result is zero |
| v | Set if result is odd, i.e. lsb is 1 |
| c | Set if result is in the interval [1:255] |

Description:

Bitwise-rotate the source operand R2 left n positions
and write the result to the destination register R1.
The amount n of the rotation is given by either R3 or
K3, modulo 16.

Example Instructions:

| | |
|---|---|
| rol | r1, r2, r3 (format 1) |
| rol | r1, r2, 5 (format 2) |

Instruction: “st” - Store to RAM

Format 1 - base displacement absolute indexed, K3=[−128:127]:
*(R2+K3)=R1

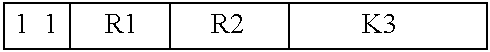

Format 2 - base displacement absolute indexed: *(R2+K3)=R1

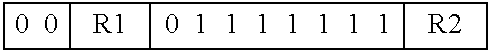

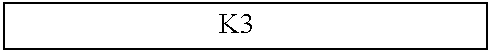

Format 3 - absolute: *K2=R1

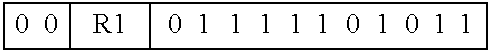

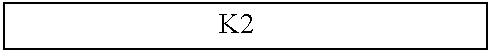

Instruction Fields:

| | |
|---|---|
| R1 | 3-bit specifier for source register |
| R2 | 3-bit specifier for base register |
| K3 | signed 8-bit or 16-bit displacement |
| K2 | 16-bit absolute address |

Condition Codes:

Not affected.

Description:

For formats 1 and 2, add the base register R2 and the
displacement K3 to form the address of the RAM
destination. For format 3, K2 is the address of the RAM
destination. Read the source register R1 and write the
result to the RAM destination.

Example Instructions:

| | |
|---|---|
| st | r1, r2, 0x11 (formats 1 & 2) |
| st | r1, 0x1FFF (format 3) |

Instruction: “sub” - 2's Complement Subtract

Format 1 - register: R1=R2−R3

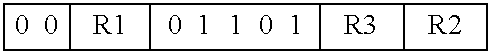

Instruction Fields:

| | |
|---|---|
| R1 | 3-bit specifier for destination register |
| R2 | 3-bit specifier for source register |
| R3 | 3-bit specifier for source register |

Condition Codes:

| | |
|---|---|
| n | Set if result is negative, i.e. msb is 1 |
| z | Set if result is zero |
| v | Set if an overflow is generated |
| c | Set if a carry is generated |

Description:

Subtract the source operands R2−R3 and write the result
to the destination register R1.

Example Instructions:

| | |
|---|---|
| sub | r1, r2, r3 (format 1) |

Instruction: “thrd” - Get Thread Number

Format 1 - register: R1=thrd( )

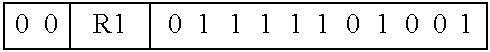

Instruction Fields:

| | |
|---|---|
| R1 | 3-bit specifier for destination register |

Condition Codes:

Not affected.

Description:

Write the thread number to the destination register R1.

Example Instruction:

thrd r1

Instruction: “xor” - Bitwise Exclusive Or

Format 1 - register: R1=R2\hat{ }R3

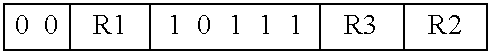

Format 2 - immediate: R1=R2\hat{ }K3

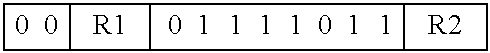

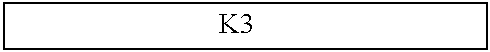

Instruction Fields:

| | |
|---|---|
| R1 | 3-bit specifier for destination register |
| R2 | 3-bit specifier for source register |
| R3 | 3-bit specifier for source register |
| K3 | 16-bit literal source |

Condition Codes:

| | |
|---|---|
| n | Set if result is negative, i.e. msb is 1 |
| z | Set if result is zero |
| v | Set if (R2 & R3) == R3, or alternatively if (R2 & |
| | K3) == K3 |
| c | Set if result is in the interval [1:255] |

Description:

Bitwise-exclusive-or the source operands and write the
result to the destination register R1.

Example Instructions:

| | |
|---|---|
| xor | r1, r2, r3 (format 1) |
| xor | r1, r2, 0x100F (format 2) |

The invention provides a system on a chip (“SOC”) architecture suitable for implementation in numerous integrated circuit technologies including conventional logic-type integrated circuits and other non-logic type integrated circuit approaches such as those used for static and dynamic RAM, FLASH, EEPROM and other approaches to memory. By utilizing various high density memory or similar non-conventional, non-logic typical processes, the SOC can be implemented at ultra low cost, at unconventionally dense logic circuit levels, and with very low power consumption.

The invention supports efficient, high-throughput, multi-stage pipeline processing capacity at low cost and power consumption making it very useful for portable and lower power consumption embedded processor designs. The pipelined design maximizes processor utilization with multiple parallel threads executing concurrently and on average one instruction completing execution every clock cycle. The architecture of the invention uses an innovative latency tolerant embedded processor and peripheral logic design, an adaptive clock technology and thread-level monitoring capability. The invention minimizes the number of gates within any logic chain by maximizing the use of parallel, shared and optimized logic and by maintaining efficient processor operations. Thread-level watch-dog processes are implemented to enhance development-related and mission-critical monitoring capabilities.

Although the invention has been described in terms of certain preferred embodiments, it will become apparent to those of ordinary skill in the art that modifications and improvements can be made to the ordinary scope of the inventive concepts herein within departing from the scope of the invention. The embodiments shown herein are merely illustrative of the inventive concepts and should not be interpreted as limiting the scope of the invention.

What is claimed is:

1. A programmable, low gate latency, system-on-chip embedded processor system for supporting general input/output applications, comprising:
a modular, multiple bit, multithread processor core operable by at least four parallel and independent application threads sharing common execution logic segmented into a multiple stage processor pipeline, wherein said processor core is capable of having at least two states;
a logic mechanism engaged with said processor core for executing an instruction set within said processor core to generate instruction state data;
a supervisory control unit, controlled by at least one of said processor core threads, for examining said core processor state and for controlling said core processor operation;
at least one memory for storing and executing said instruction set data and for storing system values; and
a peripheral adaptor engaged with said processor core for transmitting input/output signals to and from said processor core.

2. A system as recited in claim 1, wherein stages of said pipeline are capable of breaking each instruction decode operation into multiple sub-processing steps within a logic chain.

3. A system as recited in claim 2, further comprising a minimal number of gates in a logic chain to reduce the effects of gate latency.

4. A system as recited in claim 1, wherein said processor logic and system memory are constructed from substantially the same integrated circuit process technology.

5. A system as recited in claim 1, further comprising a clock adaptor mechanism for connecting an internal clock to an external crystal frequency, wherein the internal clock frequency is adjusted from said external crystal frequency and wherein said internal clock frequency can be changed dynamically by a processor thread so said internal clock operates at different frequencies than an external crystal frequency.

6. A system as recited in claim 5, wherein a setting to control the internal clock rate is stored in nonvolatile memory.

7. A system as recited in claim 6, wherein at least one memory is of a nonvolatile external type in which system settings may be stored by an external testing apparatus.

8. A system as recited in claim 5, wherein said processor internal clock frequency is programmed to be different than said external crystal frequency to compensate for external crystal operating frequency variations.

9. A system as recited in claim 5, wherein said processor internal clock frequency is programmed to be different than the external crystal frequency to synchronize the internal processor clock frequency with a derived clock frequency from a peripheral input signal.

10. A system as recited in claim 1, further comprising a clock adaptor mechanism external to and programmable by said processor core through digital outputs controlled by said processor core.

11. A system as recited in claim 1, further comprising a watchdog mechanism implemented by at least one thread checking the status of at least one other system thread through a state record updated by the checked thread and read by the checking threads.

12. A system as recited in claim 11, wherein said checking to checked thread association is statically defined.

13. A system as recited in claim 11, wherein said checking to checked thread association is a dynamic relationship governed by an algorithm.

14. A system as recited in claim 11, wherein a checking thread can alter the operation of a checked thread following identification of an unacceptable state record.

15. A system as recited in claim 11, wherein a checking thread can reset said processor core following identification of an unacceptable state record.

16. A system as recited in claim 1, wherein any of the processor threads can be disabled by said processor core to conserve power.

17. A system as recited in claim 5, wherein said processor clock frequency can be altered by any of the processor threads to conserve power.

18. A system as recited in claim 1, wherein said supervisory control unit is capable of changing the core processor operation to provide power management function.
